(19) United States
(12) Patent Application Publication
(10) Pub. No.: US 2001/0037227 A1
(43) Pub. Date: Nov. 1, 2001

(54) Customer management system for use with office products supplier

(76) Inventors: Bret McInnis, Superior, CO (US); Andre Lanthier, Marysville, MI (US)

Correspondence Address: Peter F. Weinberg, Gibson, Dunn & Crutcher LLP, Suite 4100, 1801 California St., Denver, CO, 80202, US

(21) Appl. No.: 09/797,363

(22) Filed: Mar. 2, 2001

Related U.S. Application Data
(63) Continuation of application No. 09/128,207, filed on Aug. 3, 1998, now abandoned.

(51) Int. Cl. G06F 17/60

(52) U.S. Cl. 705/7

(57) ABSTRACT

A computer software system for storing information related to a customer of a supplier enterprise, such as an office products supply enterprise, uses a hierarchical structure. The structure corresponds to the internal hierarchical structure of the customer to capture information relating to the customer's business organization entities, such as a headquarters, and operating divisions beneath the headquarters, and regions beneath the operating divisions. Information can be shared between entities up and down the hierarchy. This allows for the storage and use of the customer's hierarchical structure in the services provided by the supply enterprise. Further, custom prompts allow for the capture of information specific to each entity using that entity's own nomenclature.

### FIELD OF THE INVENTION

The present invention relates to the field of computer software (or other electronic information storage and information means), and more particularly to the field of maintaining information about customers of an enterprise using computer software. The invention is particularly adapted for maintaining information about customers of an office products supplier. Typically, the supplier supplies products to a customer that is composed of many different organizational entities.

### BACKGROUND

The office products supply business can be broadly classified into two categories. In a first category, a typically large store offers a supply of products at the store and sells primarily to individuals or small businesses that shop at the store. In a second category, a supplier delivers office products to a customer that has an on-going account with the supplier. The customer frequently has a hierarchical structure of regions, operating divisions, groups, and the like, as well as physical locations that are the “ship-to” address for ordered goods. The present invention is directed towards a supplier of the second category. The activities of such a supplier are complex, requiring in overview that myriad products be supplied to a number of shipping locations, and that the customer be billed for the products in a way that provides useful information to the customer.

Currently known software (i.e., legacy software) generally allows for a simple two-tiered structure to be created, as shown in FIG. 1 (prior art). The information in such a system consists of a “bill-to” parent with ship-to children. The two-level hierarchy of FIG. 1 allows for a minimum level of service to be provided. Basically, a business having multiple physical locations can order products from and for the separate physical locations. With continued reference to FIG. 1, a customer has a bill-to address, designated as the parent entity 10. Eleven hierarchically equivalent children 20-1 to 20-11 are set up as ship-to address. While a system according to FIG. 1 provides a certain level of functionality, it may not correspond to the actual customer hierarchy. Referring to FIG. 2, the parent 10 of FIG. 1 (labeled 50-1 in FIG. 2) may in fact be a division of another entity. As used herein, the term “entity” refers to any business organization that is related to another business organization. (Although the term entity may also encompass a customer that is composed of a single operating entity, such a customer is not the focus of the present invention.) A group of related entities will be referred to as a customer. Some of the children 20-1 to 20-11 may be divided into one operating group (e.g., the including entity 60-1), and the remainder of the children 20-1 to 20-11 may be divided into another operating group (e.g., the group including entity 60-2). This division into groups is not shown in FIG. 1, as the legacy system does not capture this information.

The legacy systems cannot utilize the information inherent in a typically complex modern customer hierarchy. Accordingly, the legacy systems do not allow for the supplier to bill, ship, report, and provide other services to the customer along hierarchical lines. It will be appreciated that customer management software that allows for an arbitrary customer hierarchy to be created will allow a supplier to provide services to the customer in excess of legacy systems. The present invention provides such software.

A primary function of customer management software is to capture information of the customer that is necessary or helpful to provide goods to the customer and to correctly bill and report to the customer for the goods. Some information, such as the customer address, should be captured for any customer (although a customer can have many addresses, so that even the storage of customer addresses may be more complex than it may appear at first). Other information, however, is specific to customers and typically cannot be recorded in legacy systems. An example of such information is a specific ship-to address that is more specific than a street address, such as a specific desk within an office. While some customers may require some information, other customers will not. A legacy system may require custom coding to store such information, which is an expensive and difficult solution. Or, in some instances a legacy system may be adapted to store such information in a field that has a different label and intended use. For example, a legacy system may have a field to store a credit account number, which could in fact be used to store very different information. This is problematic, because the system will be confusing to use and to understand. Also, it cannot be expected that the system will be able to do anything more than simply capture the information. That is, it cannot break down billing invoices and reports using the information. Some legacy systems may provide one or a few “flex fields” which are intended to be used to capture miscellaneous information supplied by an individual customer. However, such flex fields typically do not provide optimum functionality, in that they may not allow for custom data capture, validation, and reporting. The present invention provides for improved capture of customer information.

It should be understood that no documents or descriptions herein are admitted to be “prior art,” but are only mentioned to place the invention in context and to assist in a proper understanding of the invention.

As used herein, computer software is to be construed broadly to include firmware or combinations of software, firmware, and hardware, and to describe any electronic or equivalent means of capturing and manipulating data.

### SUMMARY

A computer software system for storing information related to a customer of a supplier enterprise, such as an office products supply enterprise, uses a hierarchical structure. The structure corresponds to the internal hierarchical structure of the customer to capture information relating to the customer's business organization entities, such as a headquarters, and operating divisions beneath the headquarters, and regions beneath the operating divisions. Information can be shared between entities up and down the hierarchy. This allows for the storage and use of the customer's hierarchical structure in the services provided by the supply enterprise. Further, custom prompts allow for the capture of information specific to each entity using that entity's own nomenclature.

### BRIEF DESCRIPTION OF THE DRAWINGS

FIG. 1 is a hierarchical diagram of a prior art customer management software system, as applied to a typical customer having a number of operational entities.

FIG. 2 is more complete hierarchical diagram showing the actual organization of the typical customer of FIG. 1.

FIG. 3 is a hierarchical diagram of a customer operating entities according to an embodiment of the present invention.

FIG. 4 is a process diagram of a set of operations performed according to an embodiment of the present invention.

FIG. 5 is a sales order entry screen diagram showing custom prompts according to an embodiment of the present invention.

FIG. 6 is a sales order entry screen diagram showing custom prompts according to an embodiment of the present invention, having different custom prompts than in FIG. 5.

FIG. 7 is a sample invoice generated according to an embodiment of the present invention.

FIG. 8 is a another sample invoice generated according to an embodiment of the present invention.

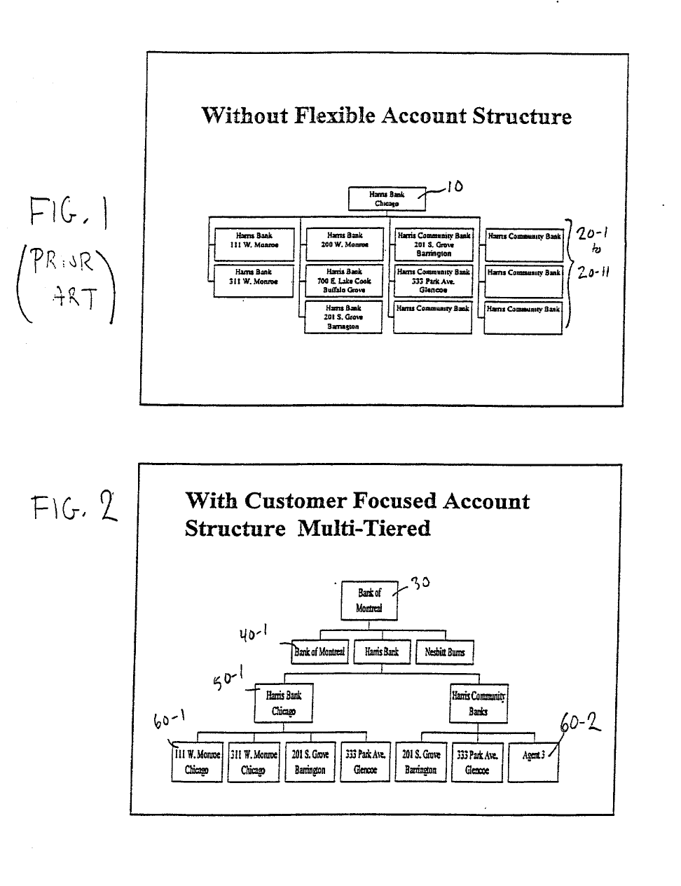

### DETAILED DESCRIPTION

The present invention provides a computer software customer management system that is useful for storing customer information in the context of an office supply enterprise. While the components of the system have been created with that purpose in mind, it can easily be understood that the system can be expected to have applicability to any similar enterprise that requires storing customer information for customers having complex hierarchical structures and that require extracting information from each hierarchical structures, and using that information to create bills and generate reports and the like.

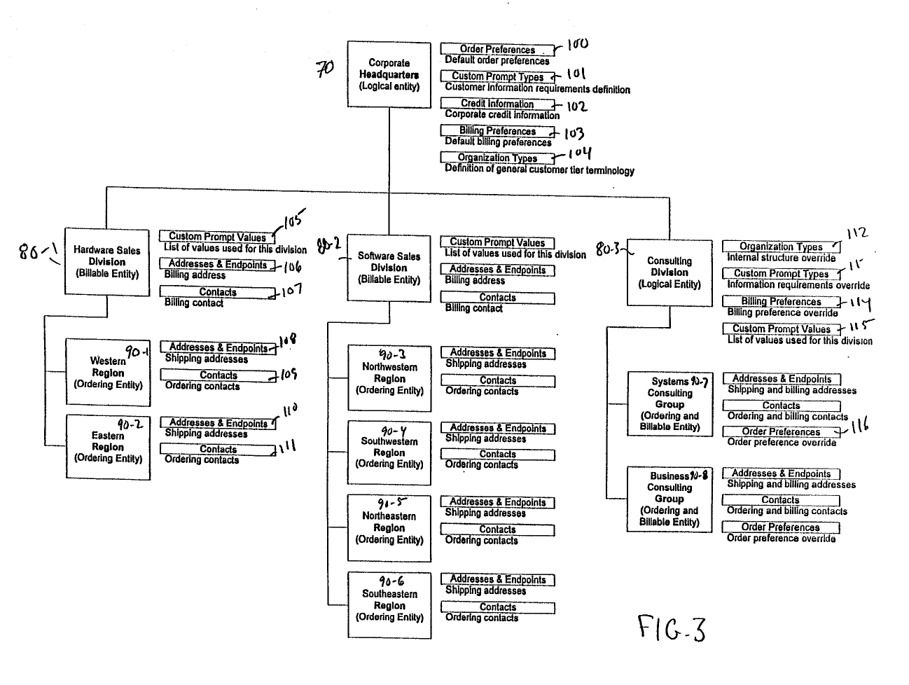

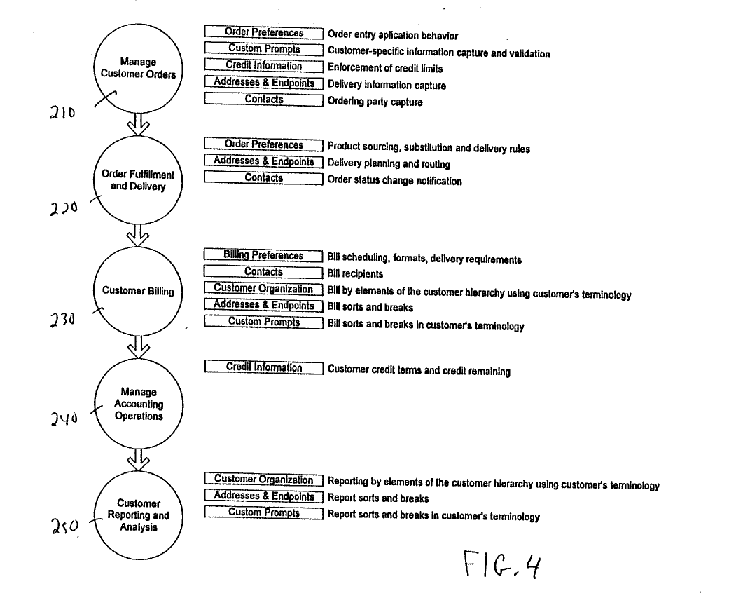

A sample customer hierarchy that is stored in a system according to an embodiment of the present invention is shown in FIG. 3. A customer hierarchy, as used herein, corresponds to an ordered collection of operating entities that together compose a customer. The precise definition of an operating entity may depend upon the business relations of a specific customer. An attribute of the present invention is that any number of diverse business structures can be accommodated.

The hierarchy has a master customer 70. The master customer 70 is the top level of a specific customer hierarchical structure. In the present example, the master customer 70 is a corporate headquarters. In general, each customer that has information stored in the system will have a master customer. The master customer 70 has three sub-customers 80-1, 80-2, and 80-3. A sub-customer (also known as a “child”) is defined as a customer that has a parent. In this case, the sub-customers 80 have as a parent the master customer 70. The sub-customers 80 in the present example are divisions (a hardware sales division 80-1, a software sales division 80-2, and a consulting division 80-3). For another customer, the level below the master customer could be another company entity, such as a region. While the significance between a “division” and a “region” is part semantical, which is significant in and of itself. Further, the attributes of different entity types will in general be different.

The sub-customers 80 each have sub-customers 90. The sub-customer 80-1 has sub-customers 90-1 and 90-2, corresponding to a Western region and an Eastern region. The sub-customer 80-2 has sub-customers 90-3 to 90-6, corresponding to a Northwestern region, a Southwestern region, a Northeastern region, and a Southeastern region. The sub-customer 90-3 has two sub-customers 90-7 and 90-8, corresponding to a systems consulting group and an business consulting group. (It should be understood that all figure reference labeling herein is arbitrary, so that what is labeled 90-1 could be labeled as 80-1-1, etc.)

As can be appreciated, each sub-customer can in turn have sub-customers. This allows for the creation of hierarchies of unlimited depth. In the terminology used herein, a “tier” represents a group of customer entities (or a single entity) that are at equivalent hierarchical levels. In this case, a first tier consists of master customer 70, a second tier consists of sub-customers 80 to 80-3, and a third tier consists of the sub-customers 90-1 to 90-8.

A primary significance of the hierarchical structure of the present invention is that each organizational entity has a set of attributes that are inherited to sub-customers (and sub-customers of the sub-customers and so on). In the present example, the master customer 70 has a set of attributes that are generally defined as: order preferences 100; custom prompt types 101, credit information 102, billing preferences 103, and organization types 104. While these attributes are present in a preferred embodiment, it can be appreciated, on one hand, that not all of the attributes will be necessary to a useful system and that, on another hand, additional attributes may be provided for.

Order preferences 101 are a set of rules that provide default instructions on how to handle each order throughout the duration of the order's life cycle. For example, an order preference rule may require that a sales order must include an order contact, which would be the person at the customer site who placed the order. Alternatively, an order preference rule may allow a sales order to include an order contact as an optional field. The default instructions can be overridden for a specific customer order.

Custom prompts 101 are a set of fields that contain customer specific information. The custom prompts 101 will in general differ from customer to customer. A custom prompt may correspond for example to “department”, which would be a field that has internal meaning to a specific customer.

The custom prompt department field may have any appearance, such as a text box, drop down list, or drop down combo box. The system field can enforce a field as required or as optional, can validate against a predefined format (such as accepting only a predefined alphanumeric string such as ###-AAAAA-##). It may also determine that a specific input conforms to a list of valid values; this is done by storing the valid values in a custom prompt values attribute. Comparison of an input value with the values attribute information ensures that the input is acceptable.

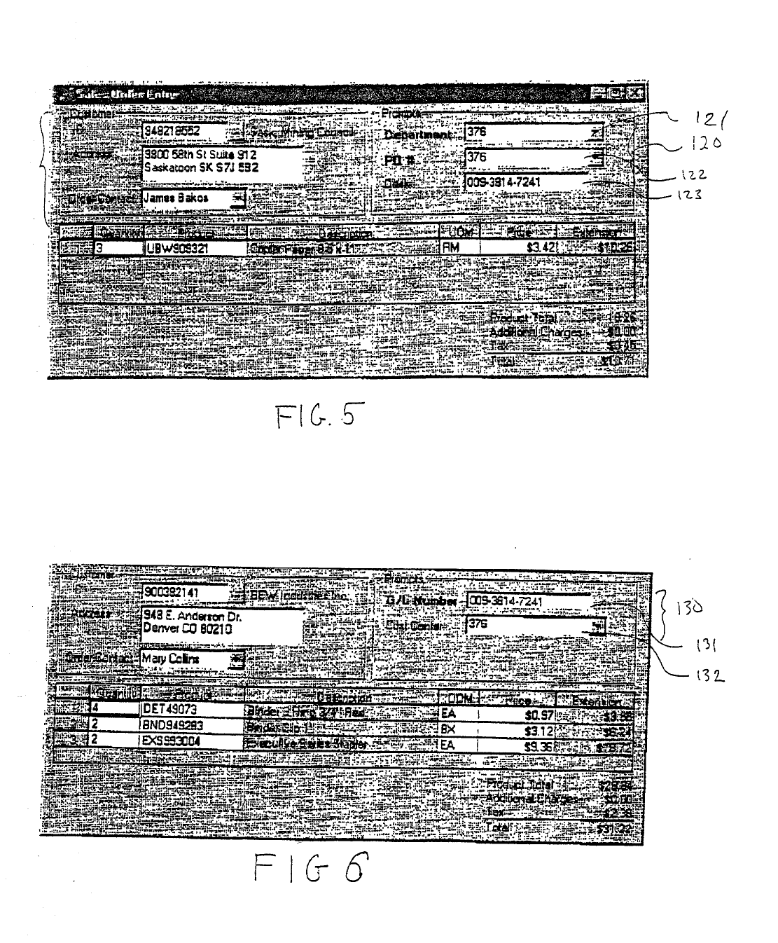

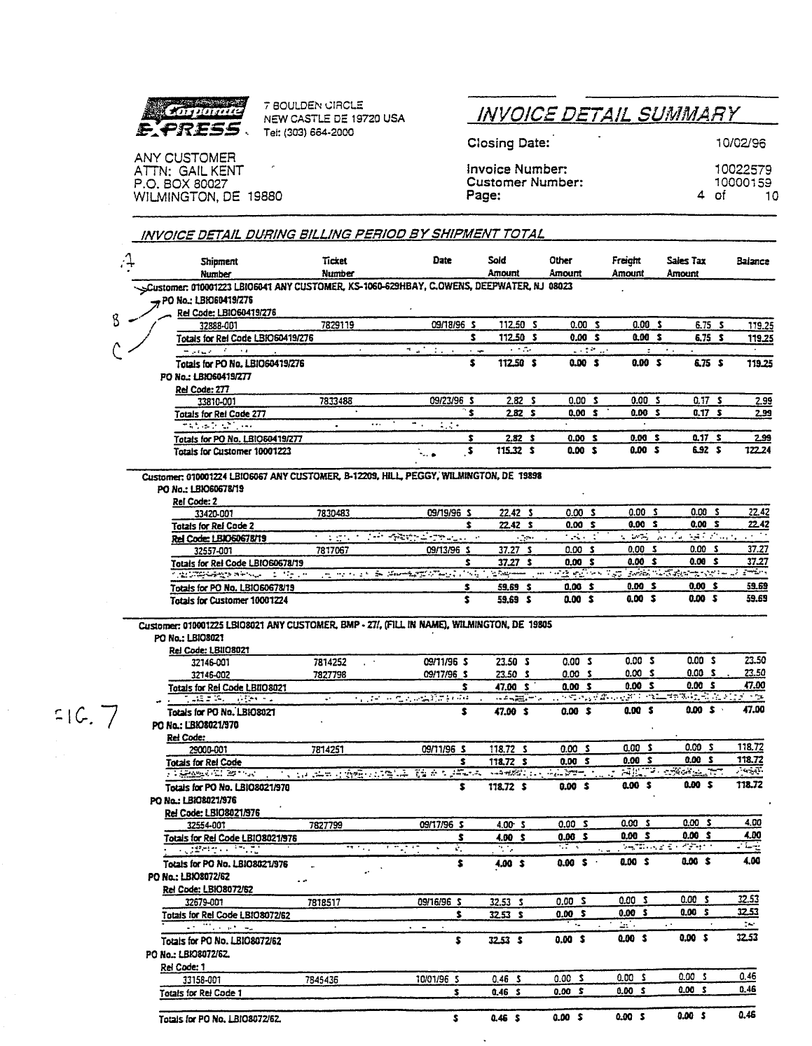

The custom prompts include the actual labels of the fields, and these labels appear on documents such as sales orders and customer reports. An example of particular prompts are shown in FIG. 5, which is a sales order entry screen as may be used in an embodiment of the invention. The sales order entry includes custom prompts generally designated 120, including a department 121, PO# (122), and a desk 123. These are fields that have specific meaning to the particular customer. The sales order entry screen also includes information generally designated as 125, which includes a customer id number, a customer address, and an order contact. A second example is shown in FIG. 6. Here, the custom prompts, generally designated 130, are a G/L number 131 and a cost center 132. These prompts are for a different customer (or entity) than in the case of FIG. 5. The order screen of FIG. 6 also includes the fields that are equivalent to fields 125 of FIG. 5, which are required prompts. In this embodiment of the invention, the information of fields 125 is applicable to all customers and entities. Each customer can then have custom prompts that are unique to the customer. While in theory there can be any number of custom prompts, a presently preferred embodiment of the invention uses up to four custom prompt fields.

Credit information 102 is information that relates to the available credit that is extended to the customer. Such credit information 102 can be used in deciding whether or not to accept a sales order submitted by a client.

Billing preferences 103 are a set of rules that relate to the billing from the supplier to the customer for the goods provided. For example, a billing preference rule may specify whether a customer will receive a bill with every shipment or a monthly statement. Another rule may specify the form of bill distribution, such as a standard paper bill or an electronic bill communicated through diskette, e-mail, etc. Copies of the bills may be sent to other entities. The billing preference rules can also specify the format of the bill, as defined in more detail below.

Organization types 104 define customer tier terminology. In the present example, the default organization type 104 rules define the headquarters 70, sub-customers 80 which are divisions, and sub-customers 90 which are regions (in the default).

The above information attributes 100-104 are inherited by the sub-customers 80 and 90 as default information. Thus, action taken by the sub-customers 80 and 90 (described in more detail below) is treated according to the information attributes 100-104. This has numerous benefits, such as: it relieves the burden of entering cumulative information relating to the various entities; it allows for information changed at one entity level to be automatically changed for every sub-customer of that one entity; and it provides for increased uniformity for the treatment of the various entities of a customer.

A related aspect of the invention is that sub-customers can supplement and/or override the information contained in the attributes of a parent customer. In the example of FIG. 3, it is assumed that each entity inherits the attributes of its parent(s) unless other attributes are depicted. For example, entity 80-1 inherits the order preferences 100, credit information, billing preferences, and organization types of master customer 70. However, it has its own custom prompt values 105. The custom prompt values correspond to the custom prompt types 101, and include acceptable values of input into the field defined by the custom prompt types which are specific to the entity 80-1, and its children 90-1 and 90-2. Entity 80-1 also has addresses and endpoint attributes 106. This attribute 106 includes a billing address for entity 80-1. Entity 80-1 also has a contacts attribute 107, that includes information about billing contacts.

Sub-customer 90-1 inherits the attributes of master customer 70 and sub-customer 80-1. It further has its own attributes of addresses and endpoints 108 and ordering contacts 109. The addresses and endpoint attributes 108 includes ship-to addresses, and the contacts attributes 109 includes ordering contacts.

Entity 80-3 inherits the attributes of master customer 70, and also has its own attributes of organization types 112, custom prompt types 113, billing preferences 114, and custom prompt values 115. The custom prompt types 113 include different and or additional custom prompts as are defined by the master customer custom prompt types 101. The custom prompt values 115 include acceptable values for the custom prompt types defined by the custom prompt types 113 (and possibly also by the master customer custom prompt types 101). The billing preferences 114 include information different from and/or additional to the master customer billing preferences 103.

The entity 80-3 organization types attributes 112 define organization types differently than the organization types attribute 104. The organization types 104 defines a second tier of divisions and a third tier of regions (as shown by representative entities 80-1 and 90-1). The organization types attributes 112 defines a second tier of divisions and a third tier of groups. The distinction between “divisions” and “groups” has semantic meaning to the customer. Further, the differing organization types has significance in defining the type of entity, such as whether it is a logical entity or otherwise as explained below.

The sub-customers 90-7 and 90-8 inherit attributes from master customer 70, customer 90-3, and also have their own attributes. For instance sub-customer 90-7 has order preferences 116 which change and/or supplement the order preferences 100 of the master customer.

Each entity of a customer is one of the following types: a logical entity, a billable entity, an ordering entity, or a billing and ordering entity. The type of entity is recorded by the system, such as by use of a flag. A billable entity is an entity that receives bills from the supplier. A billable entity must have one and only one billing address. An ordering entity is an entity that is permitted to place sales orders with the supplier. An ordering entity must have at least one ship-to address (and can have many ship-to addresses). An ordering entity must be a billing entity or have a parent (directly or indirectly) that is a billing entity. A billing and ordering entity is both of the aforementioned. A logical entity is an entity that is neither an ordering entity nor a billing entity.

The provision of logical entities (such as master 70 in the present example) is an important aspect of the invention. Legacy systems do not in general store information about an organization that has neither a ship-to address or a billing address, as such information would seem to be superfluous. However, the logical entity allows for the transmission of attributes to entities that are billing and/or ship to entities. This has the advantages of a hierarchical structure as described above. The system includes logic to ensure that the above specified conditions are present. For example, the system will not accept a hierarchy that does not have a billing entity corresponding to each ordering entity. The logic is also useful for assessing impacts of transactional changes. For example, if the status of an entity is changed from that of a billable entity to a non-billable entity, it can be verified whether the children of the entity will have a billable entity after the transaction. If not, a new billable entity must be designated.

The use of the above information in representative transactions between the customer and the supplier is now explained with reference to FIG. 4. In the step of manage customer orders 210, a sales order is created by an ordering entity. The sales order is created using the customer order preferences provided by the ordering entity. For instance, if the ordering entity is ordering entity 90-1, the order preferences 202 as defined by the master customer 70 are used. If the ordering entity is the ordering entity 90-7, the order preferences override information 116 is used. The manage customer orders step 210 also uses applicable custom prompts. So, an order placed by the sub-customer 90-7 uses the custom prompt information types 112 and values 115 as defined by the sub-customer 80-3. Similarly, the manage customer orders step 210 uses the credit information, addresses and endpoints, and contacts attributes of the relevant ordering entity.

An order fulfillment and delivery step 220 controls the delivery of goods specified in a sales order to the ordering entity. The step uses the order preferences attribute relevant to the ordering entity. In the exemplary customer of FIG. 3, all order preferences information is stored in the order preferences 70 of the master customer 70. In another example, an ordering entity could have override ordering preferences. Examples of ordering preferences are: whether an entity will accept backorders; whether an order must be shipped complete or whether partial shipments will be allowed; or whether goods must be shipped form the manufacturer or whether they may be sourced form a wholesaler. The order fulfillment and delivery step also uses the addresses and endpoint attributes for delivery routing and planning and uses the contacts attributes to alert the contact to order change status.

A customer billing step 230 generates a bill to a billing entity that is responsible for an ordering entity. A first step is to determine the identity of the billing entity for the ordering entity. This is done by reading the flag(s) that determine the entity type of the ordering entity. If the ordering entity is also a billing entity, then that entity will of course be billed. If the ordering entity is not a billing entity, then the system determines whether the parent of the entity is a billing entity. If so, then the parent is the correct billing entity. If not, then the parent of the parent is considered by the system. The above steps are repeated until the billing entity is found. For example, in FIG. 3, an order placed by sub-customer 90-3 is associated with sub-customer 80-2. The actual generated bill will depend upon the billing preferences attributes of the billing entity. Examples of options are the billing media used (paper, or e-mail, or diskette), and the formatting of the bills, and the scheduling of the bills (such as monthly or for every order). For instance, the formatting may be broken by ship-to location, or by a particular custom prompt (such as a defined cost center of GIL (general ledger) code). The customer billing step 210 may include the contacts, customer organization (for formatting using a customer's terminology, addresses & endpoints (for formatting), and custom prompts (for formatting).

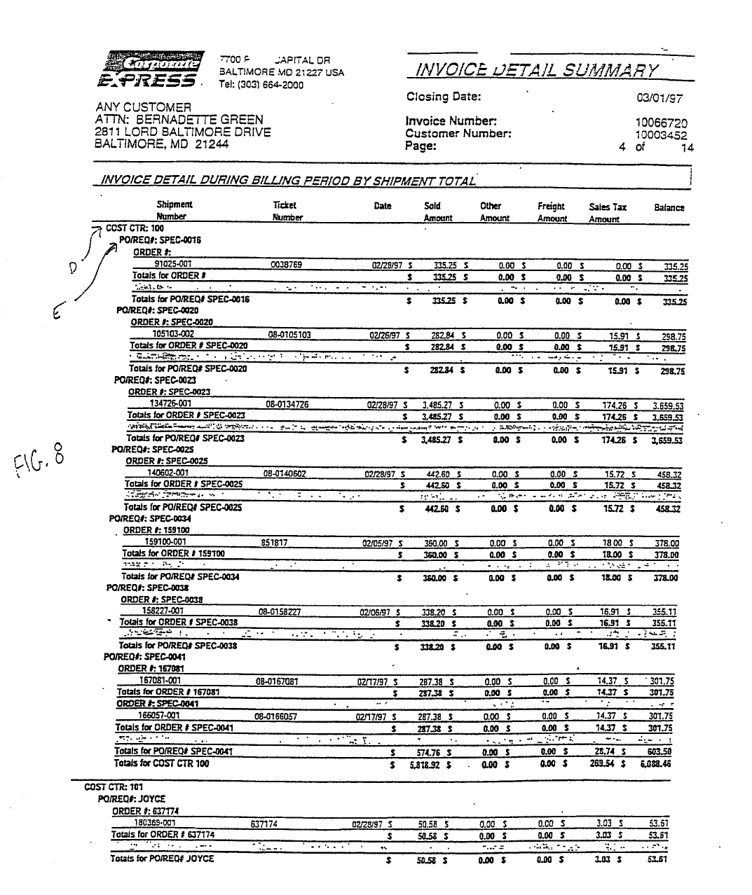

A section of a sample invoice is shown in FIG. 7. The invoice is broken down at several levels. At a first level, designated A, the invoice is broken down by customer no., which is a unique identifier of each hierarchical entity (which is not a custom prompt in this embodiment—it is required for each entity). At a second level, designated B, the invoice broken down at custom prompt “PO No.” At a third level, designated C, the invoice is broken down at the custom prompt “REL Code.” The information to generate this invoice is dictated by information within the billing preferences, such as billing preferences 114 if the entity receiving the bill is entity 90-7.

A section of another sample invoice is shown in FIG. 8. The invoice is again broken down at several levels, which differ from the levels of FIG. 7. The invoice is broken down at a first level, designated D, by a custom prompt “COST CTR.” The invoice is broken down at a second level, designated, E, by a second custom prompt “PO/REQ#.” Thus, a customer is billed with invoices that are broken down in a way that is meaningful to customer. The ability to break down by standard information (such as customer no.) or custom prompts allows for great flexibility in the formatting of invoices. For example, the invoice of FIG. 7 is primarily arranged hierarchically (since the first break is the customer no.), while the invoice of FIG. 8 is not hierarchical.

Turning once again to FIG. 4, a manage account operation step 240 uses the credit information attribute to determine and apply customer credit terms and to determine and apply remaining customer credit.

A customer reporting and analysis step 250 reports information relating to transactions of the customer. The reports are similar to bills, but report transactions instead of actual payable invoices. The reports can use information contained in the customer organization (reporting by elements of the hierarchy, using the customer specific terminology), the addresses and endpoints (formatting), and custom prompts (formatting in the customer's terminology). The reports can differ from the bills. For example, a customer may prefer to have billing performed through lower hierarchical levels and reporting broken down at higher hierarchical levels. As can be appreciated from the above discussion of FIGS. 7 and 8, the reporting information can be broken down based on any field, including custom prompts, of the system.

It should be understood that the above features of the invention can be implemented on many different computer systems in many different ways. The basic notion of storing information in database form is well known, and need not be described in detail herein. Such operations as searching a hierarchy of entities to associate information between different hierarchical levels is also well known in the field of computer science, although not, it is believed, in the present context or a related context.

It should also be understood that no feature of the invention is critical unless that is specifically noted, and that the above described invention could be used along with other features that are not described. Also, obvious modifications to the invention may be apparent to those skilled in the art. Accordingly, the scope of the invention is set forth in the appended claims and their legal equivalents.

What is claimed is:

1. A computer management system for storing information about a customer of a supply enterprise, the management system comprising:
a set of attributes associated with a first customer entity at a master customer level, the master customer level corresponding to a first hierarchical tier; a set of attributes associated with a second customer entity at a second customer level, the second customer level customer corresponding to a second hierarchical tier;
the set of attributes associated with the second customer entity potentially inheriting at least some of the attributes associated with the first customer entity; and
the second customer potentially having at least some attributes different from the first customer entity.

2. The system of claim 1, further comprising:
a set of attributes associated with a third customer entity at a third customer level, the third customer level customer corresponding to a third hierarchical tier;
the set of attributes associated with the third customer entity potentially inheriting at least some of the attributes associated with the first customer entity, the third customer potentially having at least some attributes different from the first customer entity; and
the set of attributes associated with the third customer entity potentially inheriting at least some of the attributes associated with the second customer entity, the third customer potentially having at least some attributes different from the second customer entity

3. The system of claim 1, further comprising:
another set of customer attributes associated with another customer entity at the second customer level, the set of attributes associated with the another second customer entity potentially inheriting at least some of the attributes associated with the first customer entity; and
the another customer entity potentially having at least some attributes different from the first customer entity.

4. The system of claim 2, further comprising:
another set of customer attributes associated with another customer entity at the third customer level, the set of attributes associated with the another third customer entity potentially inheriting at least some of the attributes associated with the first customer entity;
the third customer entity potentially having at least some attributes different from the first customer entity;
the set of attributes associated with the third customer entity potentially inheriting at least some of the attributes associated from the second customer entity, the third customer entity potentially having at least some attributes different from the second customer entity.

5. The system of claim 1, wherein at least some attributes are selected from the group consisting of order preferences, credit information, billing preferences, organization types, custom prompt types, contacts, and addresses and endponits.

6. The system of claim 5, wherein the system stores information related to organization types using the nomenclature of the customer.

7. The system of claim 1, whereby the system is capable of storing attribute information of an arbitrary number of customer entities at an arbitrary number of hierarchical levels, with said attribute information selectively passing across hierarchical levels.

8. The system of claim 7, wherein each customer entity is selected from the group consisting of a logical entity, a billable entity, an ordering entity, and a billing and ordering entity.

9. The system of claim 8, wherein the system has at least one logical entity at a hierarchical level, and the system has at least one ordering entity that is a child of the at least one logical entity.

10. The system of claim 8, wherein the system verifies that each ordering entity has a corresponding billable entity.

11. The system of claim 7, wherein the attribute information includes a custom prompt, the custom prompt being a filed having a customizable title to reflect a customer specific nomenclature.

12. The system of claim 9, wherein the system generates at least one of billing invoices and customer reports that break by said custom prompt.

13. The system of claim 12, further comprising a custom prompt values attribute corresponding to a custom prompt attribute, wherein the values attribute includes acceptable inputs for the custom prompt attribute.
